(19) United States
(12) Patent Application Publication
(10) Pub. No.: US 2002/0082007 A1
(43) Pub. Date: Jun. 27, 2002

(54) Method and system for expressing affective state in communication by telephone

(76) Inventors: Jyrki Hoisko, Oulu (FI); Petri Kangas, Oulu (FI); Urpo Tuomela, Oulu (FI); Kari J. Kangas, Oulu (FI); Sami Ronkainen, Oulu (FI)

Correspondence Address: PERMAN & GREEN, 425 POST ROAD, FAIRFIELD, CT, 06430, US

(21) Appl. No.: 10/023,564

(22) Filed: Dec. 18, 2001

(30) Foreign Application Priority Data
Dec. 22, 2000 (FI) 20002828

(51) Int. Cl. H04Q 7/20

(52) U.S. Cl. 455/426; 455/557; 455/556

(57) ABSTRACT

The invention relates to a method and system in which the content and intelligibility of communication by telephone are improved by means of music. Musical compositions are typically works that create in a listener an association with a certain emotion. In the invention, a suitable piece of music (10a, 10b, . . . , 10n) describing the state of mind of the caller (32) is set to be played in the background of a message to be conveyed by phone. The caller may thus communicate his affective state to the conversation partner without expressing it directly in words. Conversely, the music playing in the background of the message gives the called party (34) immediately an idea of the state of mind of the caller so that he can adopt a suitable attitude in the situation. In the invention, the musical compositions are placed in a directory (30) which may be located in the cellular phone (33, 35) of the caller or called party or in the equipment of the operator (36) switching calls. A suitable musical composition is selected by means of a menu (28) in the cellular phone or by an automatic state of mind recognizer connected to the phone.

The invention relates to a method and system for expressing the affective state of a caller and/or called party to the conversation partner in communication by telephone where the caller and called party send messages to each other.

When talking, people use a lot of expressions and gestures which reflect their emotions. The gestures and expressions complement spoken messages and may sometimes reveal more of the contents of the message than the words uttered by the interlocutors. There are also situations in which a speaker cannot or will not express his feelings in words but waits or hopes that the listener is able to infer the state of mind of the speaker and guide the conversation accordingly in the appropriate direction. In a normal conversation in which the speaker and listener are near each other and see each other all the time, the expressions and gestures of the interlocutors are easily perceived. Often the interlocutors are able, even before a single word has been uttered, to “read” the state of mind of their conversation partners in their faces and are thus able to assume an appropriate preconception of the forthcoming message. For example, a happily grinning friend may be expected to utter a humorous greeting as his first words. Similarly, when grief or worries are reflected in a friend's face, the forthcoming message may be expected to contain sadder news. The situation is not so simple when the interlocutors do not see each other. This is the case in telephone conversations, for instance. If the parties do not explicitly tell each other their emotions, they may infer them only on the basis of the tones of voice heard on the phone. Especially in the case of cellular phones, all voice signals uttered on the phone will not be conveyed to the listener because of limitations of the technology used so that it is difficult to estimate the affective state of the conversation partner. Poor audibility and interference in the calls naturally make such estimation more difficult still. As the body language based on expressions and gestures is completely left out, the nature of the conversation situation changes. Part of the intended content of the messages may then be not understood. Incorrect estimation of the affective state of a conversation partner may thus lead to misunderstandings, unintentional insults and embarrassing situations.

An object of the invention is to provide a new method and system to improve the intelligibility of communication by telephone as well as enhance the chances of the interlocutors to express their affective states in a telephone conversation.

The method and system according to the invention are characterized by that which is specified in the independent claims. Advantageous embodiments of the invention are presented in the dependent claims.

The basic idea of the invention is that the content and intelligibility of communication by telephone are improved by means of music. Musical compositions are typically works that create in a listener an association with a certain emotion. A person will listen to different kinds of music in different states of mind. A happy person will usually listen to fast, sprightly music and, conversely, a sad person usually feels that heavier, more restful music will better suit his state of mind. In this invention, a suitable musical composition reflecting the state of mind of the sender of a message is played in the background of the message conveyed on the phone. Thus the speaker is able to communicate his affective state to the conversation partner without being compelled to tell it explicitly in words. Similarly, the music playing behind the voice of the speaker will immediately give the listener an idea of the state of mind of the speaker so that the listener will be able to adopt an appropriate attitude in the situation. When the recipient of the message understands the state of mind of the caller, he is able to better interpret the things said by the caller.

An advantage of the invention is that it increases the usefulness of the cellular phone since part of the communication situations that earlier required personal intercourse can, by means of the invention, now be handled by telephone.

Another advantage of the invention is that it adds to the intelligibility of communication by telephone, thereby reducing the risk of misunderstandings and unintentional insults.

A further advantage of the invention is that it shortens phone calls as the music complements spoken messages and makes it easier to understand the message. Shorter phone calls mean smaller phone bills, thus bringing savings to the user of the phone.

A still further advantage of the invention is that it is technically feasible to implement.

The invention is below described in detail. In the description, reference is made to the accompanying drawings in which

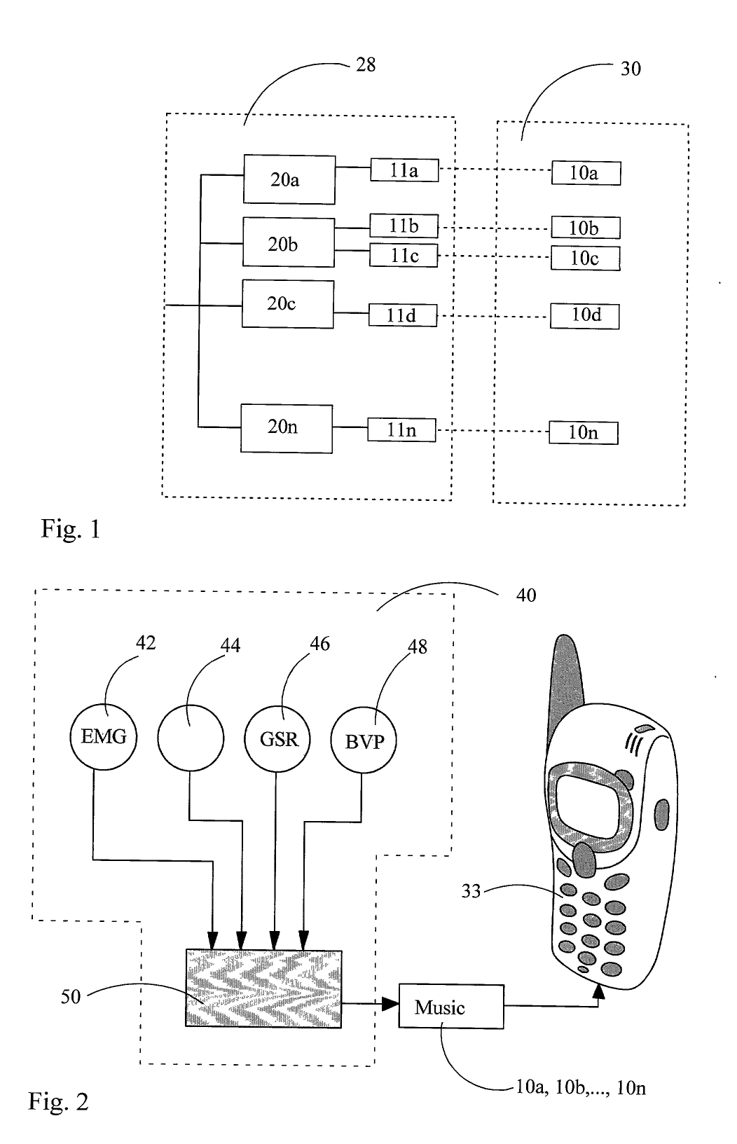

FIG. 1 shows by way of example a schematic of an advantageous embodiment of a menu used in the selection of background music,

FIG. 2 shows by way of example a schematic of an advantageous automatic state of mind recognizer,

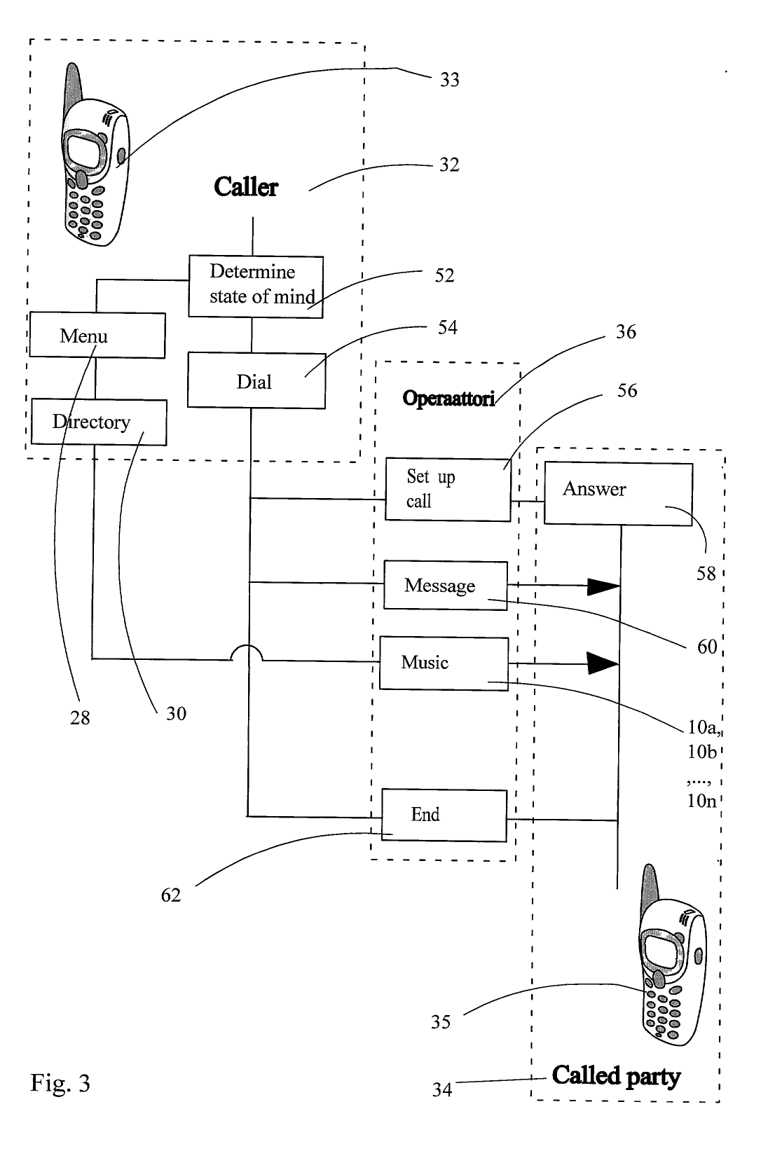

FIG. 3 shows by way of example a schematic of an advantageous embodiment of the invention,

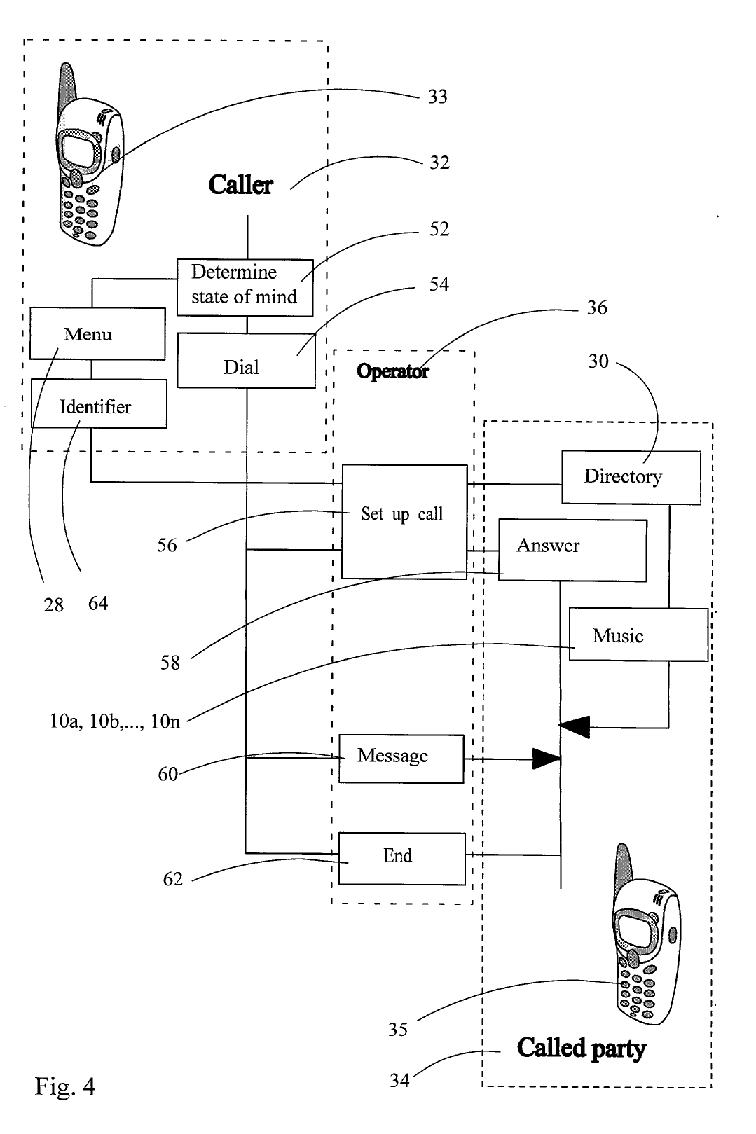

FIG. 4 shows by way of example a schematic of a second advantageous embodiment of the invention,

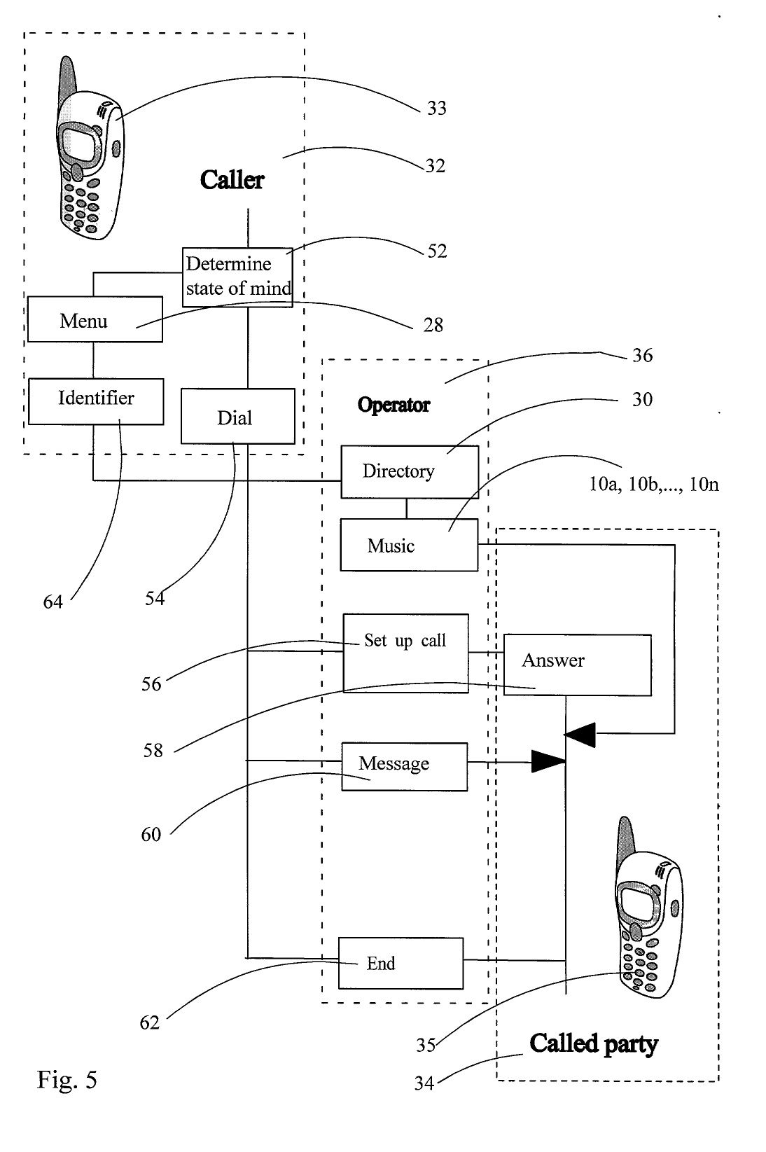

FIG. 5 shows by way of example a schematic of a third advantageous embodiment of the invention, and

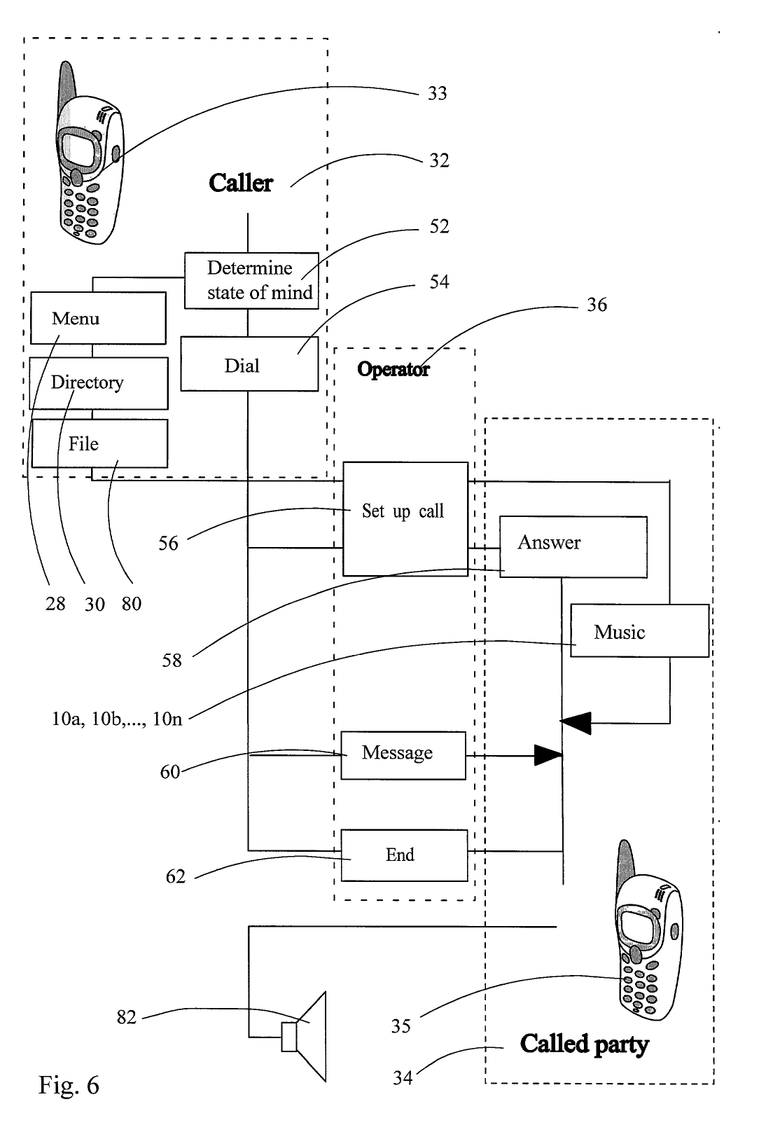

FIG. 6 shows by way of example a schematic of a fourth advantageous embodiment of the invention.

In the method according to the invention, the background music for the message is selected using a menu function implemented in the cellular phone. Suitable background music is selected from the menu either manually or by means of an automatic state of mind recognizer. Manual selection in this description refers to all selection methods that require deliberate actions of the user of the phone. One advantageous manual selection method is to browse the menu using the phone's keypad and choose a suitable emotion or musical composition. Another advantageous manual selection method is to fit a switch in the case of the cellular phone that reacts to squeezing force. In this embodiment the menu can be browsed by squeezing the switch at different levels of force so that icons representing different emotions are presented on the phone's display. As soon as the desired emotion is displayed, it is selected by pressing a key. Yet another advantageous manual selection method is to have a software-based speech recognition function in the cellular phone. In this case the user chooses a musical composition representing an emotion to be played as background music by pressing the speech recognition key and at the same time uttering the code of an emotion or musical composition.

Manual selection of an affective state is advantageously carried out in connection with the starting of a call or prior to it. The user of the phone may e.g. pre-select an emotion representing his state of mind and make it a default. Then, the background music of all messages sent after that selection will comprise the musical composition according to the default value unless the affective state is changed in connection with call set-up. Moreover, affective states or musical compositions may be selected in advance for different user groups or profiles separately. In that case, the musical composition played in the background of the message is changed on the basis of the user group to which the recipient of the message belongs.

FIG. 1 shows by way of example a schematic of an advantageous embodiment of a menu 28 used in the selection of the background music. The musical compositions 10a, 10b, . . . , 10n are stored in electric form, advantageously as midi or mp3 files, in a directory 30 which may be located in the cellular phone of the caller 32 or the called party 34 or in the operator's 36 files (FIGS. 3, 4, 5, 6). A suitable piece of music is searched in the directory by means of the menu 28 in the cellular phone. The menu contains a set of names of different affective states 20a, 20b, . . . , 20n. For example, affective state 20b may represent joy, and state 20n depression. For each affective state in the menu 28 the directory 30 contains at least one musical composition 10a, 10b, . . . , 10n which reflects the affective state in question. The names 11a, 11b, . . . , 11n of these musical compositions are also shown in the menu 28. Naturally the directory may also contain several musical compositions representing one and the same affective state. The user of the phone selects in the menu the affective state 20a, 20b . . . , 20n which in his opinion best represents his current state of mind and takes it into use in a manner described above. The background music in a call made by the user is then the musical composition 10a, 10b . . . , 10n according to the selection made. If several musical compositions are associated with the selected affective state, a system programmed in the menu functions chooses one of them. Naturally the user of the phone may also select the background music direct by the name 11a, 11b, . . . , 11n of the musical composition 10a, 10b, . . . , 10n whereby the selected musical composition is played as background music.

FIG. 2 shows by way of example a schematic of an advantageous automatic state of mind recognizer 40. The automatic state of mind recognizer is an electronic system which can be connected to a cellular phone for estimating the affective state of the user of the phone and which comprises an electromyogram (EMG) sensor 42, respiration sensor 44, galvanic skin response (GSR) sensor 46, and a blood volume pressure (BVP) sensor 48 as well as a decoding device 50 which interprets the signals transmitted by the sensors. Data gathered by the sensors are transferred to the decoding device advantageously using wireless technology. The decoding device is attached to the cellular phone 33 in either a fixed or detachable manner. On the basis of the data received from the sensors the automatic state of mind recognizer makes an estimation of the state of mind of the user of the phone and selects accordingly an appropriate affective state, whereby a musical composition representing the affective state is automatically set as the background music for the message sent.

The sensors in the automatic state of mind recognizer 40 are placed on the surface of the cellular phone user's body so that certain bodily functions and changes in them can be measured by the sensors. The EMG sensor 42 comprises a number of small electrodes attached around the neck and shoulder muscles of the user. It has been found that these muscles become tense when a person is angry, for example. The EMG sensor measures the tension of these muscles so that the measurement results indicate when the person is feeling anger.

The respiration sensor 44 is an elastic instrument fitted tightly around the chest of a person so that it stretches in accordance with the movements of the person's chest. The sensor transmits a continuous signal which varies according to the stretching of the sensor. Thus the sensor can be used to measure a person's respiration rate and breathing depth whereby it can be deduced e.g. whether the person is in a calm or excited state of mind. The respiration sensor may be a separate band-like part or it may be integrated in a tight-fitting piece of clothing covering the upper body of the user.

The GSR sensor 46 comprises two small electrodes placed against a person's skin surface at a distance from one another. Electric current flowing between the electrodes can be used to measure the skin's electric conductivity which has been found to vary according to the feeling of anxiety experienced by the person. The electrodes, which advantageously are silver chloride electrodes, may be advantageously attached to the inner surface of a glove so that they are automatically placed against the surface of a person's skin always when the person is wearing the gloves.

The BVP sensor 48 is used to measure the blood flow rate in a person's vascular system. An increase in the blood flow rate often indicates fear and anxiety. The BVP sensor emits infrared radiation onto the skin surface and measures the amount of reflected radiation whereby the person's blood flow rate can be estimated. The BVP sensor may be advantageously attached on the finger tip of a glove.

The decoding device 50 is an electronic device which receives the signals coming from the sensors and uses them to make an estimation of a person's state of mind. Based on the estimation, the decoding device selects the most suitable of the affective states available so that a musical composition representing that particular affective state is automatically set as the background music for the message to be sent, the message being advantageously a voice message. A cellular phone may be programmed so as to include a function which requests the user of the phone to confirm the affective state selected by the decoding device e.g. by pressing a key on the phone. The user of the phone may also choose whether the phone's automatic state of mind recognizer is on or off. The automatic state of mind recognizer may also be used together with the manual affective state selection. For example, at the beginning of a call the caller may set his affective state manually, and during the call the automatic state of mind recognizer monitors the caller's state of mind and changes the affective state selection when needed.

In addition to the sensors mentioned above the automatic state of mind recognizer may be connected to other biosignal sensors, recognition devices or cameras in order to measure the bodily functions of the user of the phone so that the state of mind of the user can be estimated on the basis of the data produced by such devices. The state of mind may be estimated on the basis of the voice or facial expressions of the speaker, for example.

FIG. 3 shows by way of example an advantageous embodiment of the method according to the invention. In this embodiment, the directory 30 containing the musical compositions 10 to be used as background music for messages 60, is located in the cellular phone 33 of the caller. When starting the call, the caller first determines his state of mind 52. He may do it independently based on his own judgment, or it may be done by the automatic state of mind recognizer 40 depicted in FIG. 2. On the basis of the state of mind, a suitable affective state 20a, . . . , 20n or musical composition 10a, 10b, . . . , 10n is selected from a menu 28. Based on address information provided by the menu, the right musical composition is fetched from the directory 30. After that, the caller makes a call 54 to a person. Advantageously the call is made by entering on the caller's 32 cellular phone 33 the phone number of the cellular phone 35 of the called party 34. The call is connected 56 by an operator 36, after which the called party 34 answers 58 the phone. Now the caller and called party are in communication connection with each other and can send messages 60 to one another by means of the phone. Messages transmitted on the phone may advantageously be voice messages or they may contain e.g. images or text in addition to or instead of speech. The voice of the caller can be heard on the cellular phone 35 of the called party, and music selected by the caller can be heard in the background of the voice. In this advantageous embodiment of the invention the sound of the musical composition is transferred, like speech, on an audio channel from the cellular phone 33 of the caller to the cellular phone 35 of the called party. The call is terminated 62 normally by hanging up one of the phones whereby messages and music cease to be transferred between the phones.

FIG. 4 shows by way of example a second advantageous embodiment of the method according to the invention. In this embodiment the directory 30 containing musical compositions is located in the cellular phone 35 of the called party 34. When starting a call, the caller 32 determines his state of mind 52 and selects from the menu 28 the appropriate affective state or musical composition, whereby an identifier 64 for the selected affective state or musical composition is stored in the phone's memory. After that, the caller makes a call 54 to a person and the operator 36 connects the call 56. At this stage the identifier 64 for the affective state or musical composition selected by the caller is transferred via the operator to the cellular phone 35 of the called party 34. On the basis of the identifier a suitable musical composition 10a, 10b, . . . , 10n is searched in the directory 30 in the cellular phone of the called party and played on his phone when he answers 58 the phone.

In this advantageous embodiment of the invention, only the identifier of the musical composition 64, in addition to speech, is transferred from the cellular phone of the caller to the phone of the called party where the said identifier is used to search a suitable musical composition in the directory in the phone. The identifier may comprise the name 11a, . . . , 11n of a certain musical composition or just the name of an affective state 20a, . . . , 20n representing the state of mind of the caller. The voice of the caller is transferred normally on an audio channel from the cellular phone of the caller to the phone of the called party, and the called party will hear the music representing the state of mind of the caller in the background. The call is terminated 62 normally by hanging up one of the phones whereby also the music ceases to be played on the phone of the called party.

FIG. 5 shows by way of example a third advantageous embodiment of the method according to the invention. In this embodiment, the directory 30 containing musical compositions is located in the operator's 36 equipment. When starting a call, the caller 32 determines his state of mind 52 and selects in the menu 28 the name of an affective state or musical composition, whereby a corresponding identifier 64 is stored in the phone's memory. After that, the caller makes a call 54 to a person and the operator 36 connects the call 56. At this stage the identifier 64 is transferred from the cellular phone of the caller to the operator 36, and on the basis of the identifier a suitable musical composition 10a, 10b, . . . , 10n is searched in the directory 30 in the operator's equipment. When the called party answers the phone, the operator adds the signals of the musical composition onto the same channel with the message 60 sent by the caller. Thus the called party hears the music on his phone in the background of the message sent by the caller. The call is terminated normally by hanging up one of the phones whereby also the music ceases to be played.

FIG. 6 shows by way of example a fourth advantageous embodiment of the method according to the invention. In this embodiment, the directory 30 containing the musical compositions 10 to be used as background music is located in the cellular phone 33 of the caller. The musical compositions are stored in the directory as files 80 which may be playable audio files, advantageously midi or mp3 files, or data files containing the notes of the musical compositions. When starting the call, the caller first determines his state of mind 52 and, based on that, selects in a menu 28 an affective state 20a, . . . , 20n or musical composition 10a, 10b, . . . , 10n representing his state of mind. Based on address information provided by the menu, the file 80 of the musical composition is searched in the directory 30. After that, the caller makes a call 54 to a person, and the operator connects the call 56. When the call is ready, the file 80 is transferred in its entirety through the operator to the cellular phone 35 of the called party 34. As the called party answers the phone, the music 10 contained in the file 80 starts to play essentially simultaneously with the voice heard on the phone. The called party can choose whether to listen to the music on his cellular phone or on a separate sound reproduction apparatus 82, like e.g. loudspeakers, connected to the cellular phone.

In this advantageous embodiment of the invention there is transferred from the cellular phone of the caller to the cellular phone of the called party, in addition to speech, an electric file 80 which contains the selected musical composition as a sound recording, or the note data needed to reproduce the musical composition. The called party can choose the device on which he wants to play the music. Thus the cellular phone may serve purely as a file receiving device from which the file is transferred to a selected sound reproducing apparatus 82 such as a home stereo system of the called party. Advantageously the cellular phone of the called party includes a function by means of which the called party may in advance direct all music data files arriving in connection with calls to be played on a certain device chosen by him. The voice of the caller is transferred normally on an audio channel from the cellular phone of the caller to the phone of the called party, and simultaneously with the voice a musical composition describing the affective state of the caller is played on a device selected by the called party. The call is terminated 62 normally by hanging up either one of the phones whereby also the music stops.

FIGS. 3, 4, 5 and 6 illustrate advantageous embodiments of the method according to the invention. These embodiments differ from each other only in the technical and software implementation of the method. All solutions are technically feasible and require only minor hardware and/or software changes in the cellular phones and/or operator equipment. The transfer of identifiers or files between cellular phones and operator in conjunction with call establishment can be realized using a known signalling technique widely used in cellular phones. Advantageously the identifiers and files may be transferred using the UUS (User-to-User) signalling technique according to the ETSI GSM 4.87 V7.0.0 specification. From the point of view of the user of the phone there are no significant differences between the embodiments described, for the visible functions associated with the selection of the affective state can be carried out substantially in a like manner in all embodiments.

In FIGS. 3, 4, 5 and 6 it is presented how a musical composition is associated as background music with a message sent by the caller 32. Naturally, telephone communication is bi-directional and, in accordance with the principles described above, a musical composition can be set to play in the background of a message sent by the called party 34 as well, so that the caller 32 hears it on his cellular phone. It is obvious that phones can be used to send not only spoken messages but other kinds of messages, too. The messages may contain in addition to or instead of speech also images or text, for example. The method according to the invention can be used also in such telephone communication in order to express affective states of the communicating parties.

The method according to the invention can be used in calls of all types. An example of such everyday calls between acquaintances could be a call made by a teenage girl to her friend. If the caller is feeling depressed or a little sad, she may select a sad piece of music as background music for the call. The called party will hear the music in the background and know that the caller is sad. The called party may select a cheerful piece of music to be played in the background of her voice and guide the conversation towards happier topics and thus cheer the caller up.

By means of the method according to the invention the user of the phone may also communicate his or her situation to the caller. For example, a person answering a phone may be in a great hurry and doesn't have time to be on the phone for a long time. He may then select as background music a fast-paced composition which plays in the background always when answers the phone. The background music discreetly tells the caller that the called party is in a hurry at the moment so that the caller knows that he should speak briefly.

Yet another example of using the method according to the invention is the communication of sad tidings by telephone. When the caller wants to tell his acquaintances or friends about the death of a friend or relative, for instance, he may choose as background music a hymn or a peaceful classical composition. The called party will hear the music when answering the call and immediately understand that the caller has some serious and sad news to tell. This way he is able to adopt a sympathetic attitude right away, making it easier for the caller to tell the sad news.

Above it was described a few possible situations in which the method according to the invention could be used. Naturally, the method according to the invention may be used in calls of other kinds, too. Pieces of music may be used in the background even if they are not used to express a particular affective state. For example, the user of the phone may select as background music a composition performed by his favourite singer or group and thus communicate to his conversation partners something about his personality.

In an advantageous embodiment of the method according to the invention a musical composition is set to be played in the background of a text message sent by cellular phone. GSM phones, for example, include a so-called SMS (Short Message Service) feature enabling the sending of text messages between phones. The GSM standard gives manufacturers a choice to add proprietary data at the beginning of the text message. Thus the sender of a text message may add to this so-called User-Data-Header an identifier referring to a piece of music or affective state. Another advantageous method is to add the identifier of an affective state or musical composition to the beginning of the text message in the form of text and separate it from the rest of the text by special symbols by means of which the receiving apparatus will know that the identifier represents information required for indicating a piece of music or an affective state. The identifier in question is transferred together with the text message to the cellular phone of the called party, whereby the correct musical composition is searched in the directory in the cellular phone of the called party and played when the user of phone reads the text message. Thus a bride and groom, for example, may announce their forthcoming wedding by sending a text message to their friends and relatives and choose a wedding march to play in the background of the message. This way the recipient of the text message, while reading the message, will hear a musical composition in the background complementing the message.

Above it was described some advantageous embodiments of the method according to the invention. The present invention finds particular utility in cellular phones but it can also be used, where applicable, in phones utilizing the traditional wired network. The invention is also applicable when one of the phones of the conversing parties is a phone belonging to a wired network and the other a cellular phone.

The invention is not limited to the solutions described above but the inventional idea can be applied in numerous ways within the limits defined by the claims attached hereto.

1. A method for expressing an affective state (20a, 20b, . . . , 20n) of the caller (32) and/or called party (34) to the conversation partner in communication by telephone, where the caller and called party send each other messages (60) wherein during the communication, the recipient of a message hears a musical composition (10a, 10b, . . . , 10n) representing the affective state of the sender of the message.

2. A method according to claim 1 wherein the messages (60) of the caller (32) and called party (34) are speech messages.

3. A method according to claim 1 wherein the communication takes place in a system comprising equipment of an operator (36) switching calls and in which system at least one phone is a cellular phone (33, 35).

4. A method according to claim 3 wherein the phone of the caller (32) is a cellular phone (33) and that the musical composition (10a, 10b, . . . , 10n) is attached to the message (60) sent by the caller in the caller's cellular phone.

5. A method according to claim 4 wherein the musical composition (10a, 10b, . . . , 10n) is transferred together with the message (60) on the same audio channel from the cellular phone (33) of the caller (32) to the phone of the called party (34).

6. A method according to claim 3 wherein the phone of the called party (34) is a cellular phone (35) and that the musical composition (10a, 10b, . . . , 10n) is attached to the message (60) sent by the caller (32) in the cellular phone of the called party.

7. A method according to claim 6 wherein there is transferred from the cellular phone (33) of the caller (32) to the cellular phone (35) of the called party (34) an identifier (64) on the basis of which the musical composition (10a, 10b, . . . , 10n) is selected.

8. A method according to claim 7 wherein the identifier (64) specifies the name (11a, 11b, . . . , 11n) of the musical composition (10a, 10b, . . ., 10n).

9. A method according to claim 7 wherein the identifier (64) specifies the affective state (20a, 20b, . . . , 20n) of the caller (32).

10. A method according to claim 3 wherein the musical composition (10a, 10b, . . . , 10n) is attached to the message (60) sent by the caller (32) in the equipment of the operator (36) switching the call.

11. A method according to claim 10 wherein there is transferred from the cellular phone (33) of the caller (32) to the operator (36) an identifier (64) on the basis of which the musical composition (10a, 10b, . . . , 10n) is selected.

12. A method according to claim 11 wherein the identifier (64) specifies the name (11a, 11b, . . . , 11n) of the musical composition (10a, 10b, . . . , 10n).

13. A method according to claim 11 wherein the identifier (64) specifies the affective state (20a, 20b, . . . , 20n) of the caller (32).

14. A method according to claim 3 wherein the phones of the caller (32) and called party (34) are cellular phones (33, 35) and from the cellular phone of the caller to the cellular phone of the called party there is sent a file (80) which contains a musical composition (10a, 10b, . . . , 10n) stored in electric form.

15. A method according to claim 14 wherein the musical composition (10a, 10b, . . . , 10n) is set to be played on the cellular phone (35) of the called party (34).

16. A method according to claim 14 wherein the musical composition is set to be played on a separate sound reproducing apparatus (82) connected to the cellular phone (35) of the called party (34).

17. A system for expressing an affective state of a caller (32) and/or called party (34) to the conversation partner in communication by telephone, where the caller and called party send each other messages (60), which system comprises at least one cellular phone (33, 35) and the equipment of an operator (36) switching calls, wherein the system further comprises a directory (30) storing musical compositions (10a, 10b, . . . , 10n) representing various affective states (20a, 20b, . . . , 20n) and a menu (28) for selecting musical compositions in the directory.

18. A system according to claim 17 wherein the musical compositions (10a, 10b, . . . , 10n) are stored in the directory (30) in electric form.

19. A system according to claim 17 wherein the musical compositions (10a, 10b, . . . , 10n) are stored in the directory (30) in the form of midi or mp3 files.

20. A system according to claim 17 wherein the directory (30) is in the cellular phone (33) of the caller (32).

21. A system according to claim 17 wherein the directory (30) is in the cellular phone (35) of the called party (34).

22. A system according to claim 17 wherein the directory (30) is in the equipment of the operator (36).

23. A system according to claim 17 wherein the menu (28) is arranged to be at least in the cellular phone (33) of the caller (32).

24. A system according to claim 17 wherein the system further comprises an automatic state of mind recognizer (40).

25. A system according to claim 24 wherein the automatic state of mind recognizer (40) is arranged to be in the cellular phone (33) of the caller (32).

26. A system according to claim 24 wherein the automatic state of mind recognizer (40) is arranged to be in the cellular phone (35) of the called party (34).

27. A system according to claim 24 wherein the automatic state of mind recognizer (40) includes a set of sensors (42, 44, 46, 48) measuring the bodily functions of the user of the phone and a decoding device (50) which processes the measurement results produced by the sensors.

28. A system according to claim 27 wherein the automatic state of mind recognizer (40) includes an EMG sensor (42) for measuring the tension of neck muscles.

29. A system according to claim 27 wherein the automatic state of mind recognizer (40) includes a respiration sensor (44) for measuring the respiration rate and depth of breathing.

30. A system according to claim 27 wherein the automatic state of mind recognizer (40) includes a GSR sensor (46) for measuring the electrical conductivity of skin.

31. A system according to claim 27 wherein the automatic state of mind recognizer (40) includes a BVP sensor (48) for measuring the blood flow rate.
